(19) United States
(12) Patent Application Publication
(10) Pub. No.: US 2013/0177658 A1
(43) Pub. Date: Jul. 11, 2013

(54) Methods of Preparing a Metal Nanoparticle-Containing Silicone Composition

(71) Applicants: Matt Dowland, Midland, MI (US); Nanguo Liu, Midland, MI (US); Shawn Keith Mealey, Midland, MI (US)

(72) Inventors: Matt Dowland, Midland, MI (US); Nanguo Liu, Midland, MI (US); Shawn Keith Mealey, Midland, MI (US)

(73) Assignee: Dow Corning Corporation, Midland, MI (US)

(21) Appl. No.: 13/823,006

(22) PCT Filed: Sep. 30, 2011
(86) PCT No.: PCT/US2011/054343

§ 371 Date: Mar. 13, 2013

Related U.S. Application Data
(60) Provisional application No. 61/388,161, filed on Sep. 30, 2010.

(51) Int. Cl. A01N 25/10

(52) U.S. Cl. CPC A01N 25/10
USPC 424/618

(57) ABSTRACT

This invention relates to methods for preparing metal nanoparticle-containing silicone compositions, such as silver nanoparticle-containing compositions. The metal nanoparticles are prepared by reducing a soluble metal salt with an SiH-containing material or other reducing material in an organic solvent. Silicone materials are added either before or after addition of the reducing agents. The organic solvent is then removed.

### FIELD OF THE INVENTION

The invention relates to methods for preparing metal nanoparticle-containing silicone compositions, such as silver nanoparticle-containing compositions. The processes can produce an uncured, solvent-free composition.

### BACKGROUND OF THE INVENTION

Many methods have been developed for silver nanoparticle synthesis by academic and industrial researchers. The silver nanoparticles are typically prepared in aqueous media by reducing AgNO₃ with various reducing agents, such as NaBH₄, ascorbic acid, ethylene glycol, aldehyde, or glucose. Various polymers (such as PVP and polyacrylates) and organic ligands (such as oleate) have been used to stabilize Ag nanoparticles and transfer them into organic solvents. None of these methods, however, have shown evidence of producing silver nanoparticle-containing compositions that have both good compatibility and good flexibility with silicone materials.

Rice University developed a process to prepare Ag-containing silicone materials. See U.S. Patent Application Publication No. 2010/0120942 A1. The process includes the steps of 1) dissolving a silver salt (such as silver benzoate) in a nonpolar solvent (such as hexane); 2) mixing the silver salt solution with a silicone formulation that includes a polymerization agent (for instance, the formulation can include vinyl-terminated PDMS, a SiH cross-linking agent, and a Pt catalyst); 3) casting the films on a substrate; and 4) curing the film at an elevated temperature. Ag nanoparticles (5-20 nm) are formed in-situ during the curing step. This method, however, lacks flexibility in the final product as well as flexibility in controlling the size of Ag nanoparticles. By placing a polymerization agent that performs a dual role of reducing the metal salt and polymerizing the polymerizable material (see paragraph [0084]), there is no ability to produce an uncured silicone composition. Additionally, removal of the solvent in this process will likely be difficult to accomplish, if possible at all, which may present additional problems and/or limitations during curing. These hindrances may be problematic for various applications and may limit the ability of the composition to be used in a wide variety of articles.

There is thus a need for methods for preparing silver nanoparticle-containing silicone compositions that have both strong antimicrobial activity and good flexibility.

This invention answers that need.

### SUMMARY OF THE INVENTION

This invention relates to a method of preparing a solvent-free, uncured metal nanoparticle-containing silicone composition. The method involves (a) reacting a soluble metal salt dissolved in an organic solvent with a reducing material to form a mixture; (b) adding an organopolysiloxane composition to the mixture; and (c) removing the organic solvent, to form a solvent-free, uncured metal nanoparticle-containing silicone composition.

The invention also relates to a method of preparing a solvent-free, uncured metal nanoparticle-containing silicone composition. This method involves (a) adding a soluble metal salt dissolved in an organic solvent to an organopolysiloxane composition to form a mixture; (b) adding a reducing material to the mixture; and (c) removing the organic solvent, to form a solvent-free, uncured metal nanoparticle-containing silicone composition.

### DETAILED DESCRIPTION

Nanoparticle formation in silicone compositions and the ability to tailor the nanoparticles in a manner that provides increased functionality and flexibility can be achieved through the methods of this invention. The nanoparticle technology involves the reduction of metal salts, such as silver carboxylates, with SiH-containing compositions (or other reducing agents) in an organic solvent. Silicone materials, such as polydimethylsiloxane (PDMS), can then be added into the metal nanoparticle solution. After solvent removal, a stable dispersion of metal nanoparticles in the silicone materials are formed. Advantageously, this enables the metal to impart functionality into the silicone materials. For instance, silver nanoparticles can impart antimicrobial functionality. The solvent-free, uncured aspects of the silicone composition allows for the flexibility of using the composition in a wide variety of articles.

Thus, one aspect of this invention relates to a method of preparing a solvent-free, uncured metal nanoparticle-containing silicone composition. The method involves (a) reacting a soluble metal salt dissolved in an organic solvent with a reducing material to form a mixture; (b) adding an organopolysiloxane composition to the mixture; and (c) removing the organic solvent, to form a solvent-free, uncured metal nanoparticle-containing silicone composition.

The invention also relates to another method of preparing a solvent-free, uncured metal nanoparticle-containing silicone composition. This method involves (a) adding a soluble metal salt dissolved in an organic solvent to an organopolysiloxane composition to form a mixture; (b) adding a reducing material to the mixture; and (c) removing the organic solvent, to form a solvent-free, uncured metal nanoparticle-containing silicone composition.

Any metal salt that is capable of being dissolved in an organic solvent may be used as the soluble metal salt. The metal of the metal salt may be silver, gold, copper, platinum, palladium, ruthenium, rhodium, other known metals, or a combination thereof. As appreciated by one of skill in the art, various known ions form or may be combined with the metals to form metal salts. The metal salt may be commercially available as a metal precursor or prepared through means known in the art. For example, the metal salt may be a metal carboxylate, for instance metal carboxylates of the formula M—O₂CR, where M is the metal and R is an organic substituted or unsubstituted C₂-C₂₄ group with or without unsaturation. Representative carboxylates include, but not limited to, neodecanoates, naphthenates, octoates, dioctoates, stearates, butyrates, acetates, diacetate, laurates, dilaurates, adipates, benzoates, dibenzoates, lactates, dilactates, sebacates, acetylacetates, methacrylates, acrylates, and cinnamates. The metal salt may also be a metal alkyl sulfate, aryl sulfate, sulfonate, alkyl sulfonate, aryl sulfonate, or various other suitable ions that can be combined with the metal to form a soluble metal salt.

The metal salt can be dissolved in an organic solvent through means known in the art. Polar solvents and non-polar solvents may both be used. Suitable organic solvents include tetrahydrofuran, chloroform, methylene chloride, methylene dichloride, vegetable oil, toluene, xylene, heptanes, ethanol, butanol, octane, and mixtures thereof.

In one embodiment, the metal is silver and the soluble silver salt is a silver carboxylate, silver alkyl sulfate, silver aryl sulfate, silver alkyl sulfonate, silver arylsulfonate, or an organosilver compound. For instance, the silver salt is a silver C₃-C₂₈ carboxylate salt.

The reducing material may be any compound capable of reducing the metal salt, such as a SiH-containing composition or a compound containing one or more aldehyde groups. An equivalent ratio or more of reducing material to metal can be used, as it is desirable to have the molar ratio of the reducing material to metal sufficient to ensure that all, or at least most, of the metal is reduced. Typically larger amounts of reducing materials are used to achieve this goal. For instance, the equivalent ratio of the reducing material to metal typically ranges from 1 to 10, or from about 1.1 to about 4.0.

The SiH-containing composition may be defined as containing 1 to 10,000 building blocks which have a general formula (I): R¹ₐR²_{b}R³_{c}SiO_{(4-a-b-c)/2}, where a, b, and c are each an integer selected from 0, 1, 2, or 3, where a+b+c≦3, each R¹, R², and R³ is an independently selected hydrogen atom, or chlorine atom, or hydroxide group, or alkoxide group having a general formula (II): R⁴O—, where R⁴ is an alkyl group having 1-18 carbon atoms or an aryl group having from 6 to 12 carbon atoms, or alkyl group having 1 to 18 carbon atoms, or alkenyl group having 2-18 carbon atoms, or epoxy group having 3-18 carbon atoms, or carbinol group having 1-18 carbon atoms, or aryl group having from 6 to 12 carbon atoms, or polyether group having a general formula: (III) —(R⁵O)_{q}R⁶, where q is a value from 1 to 30, each R⁵ is an independently selected divalent alkylene group having from 2 to 6 carbon atoms, and R⁶ is an independently selected hydrogen atom or monovalent alkyl group having from 1 to 6 carbon atoms.

Formula (I) is represented by M, D, T, and Q building blocks. By definition, an “M” building block refers to a siloxy unit that contains one silicon atom bonded to one oxygen atom, with the remaining three substituents on the silicon atom being other than oxygen. A “D” building block refers to a siloxy unit that contains one silicon atom bonded to two oxygen atoms, with the remaining two substituents on the silicon atom being other than oxygen. A “T” building block refers to a siloxy unit that contains one silicon atom bonded to three oxygen atoms, with the remaining one substituent on the silicon atom being other than oxygen. A “Q” building block refers to a siloxy unit that contains one silicon atom bonded to four oxygen atoms. Their molecular structures are listed below:

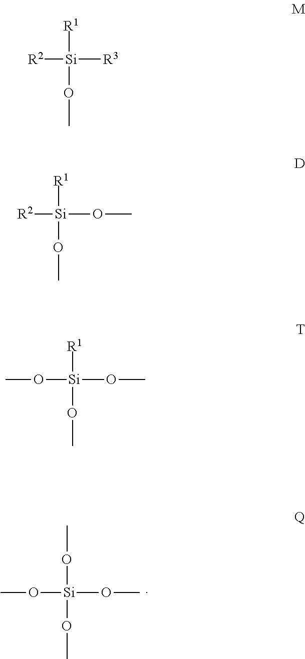

Each of the open bonds from the oxygen atoms, designated as —O——, indicates a position where that building block may be bonded to another building block. Thus it is through the oxygen atom that a first building block is bonded to a second or subsequent building block, the oxygen bonding either to another silicon atom or one of the R groups in the second or subsequent building block. When the oxygen atom is bonded to another silicon of the second building block, the oxygen atom represented in the first building block acts as the same oxygen atom represented in the second building block, thereby forming a Si—O—Si bond between the two building blocks.

In one embodiment, the number of building blocks (M, D, T, Q) in the SiH-containing compositions is from 1 to 1000. The SiH-containing composition must contain at least one M, at least one D, or at least one T building block. In other words, the SiH-containing composition cannot contain all Q building blocks. If there is only one building block, it can only chosen from M, D, or T.

At least one of the R¹, R², and R³groups from the building blocks in the SiH containing compositions must be hydrogen. Any open or available bond from the oxygen atoms, indicated as —O——, that are not bonded to another building block can instead be represented as —OR′, where R′ is hydrogen, a C₁-C₁₈ alkyl, or a C₆-C₁₂ aryl, in the SiH-containing composition.

The alkyl group having 1 to 18 carbon atoms of R¹, R², and R³ in Formula (I) is a monovalent alkyl group having from 1 to 18 carbon atoms. Alternatively, the alkyl group comprises 1 to 6 carbon atoms; alternatively, the alkyl group is methyl, ethyl, propyl, butyl, or hexyl.

The alkenyl group having 2-18 carbon atoms of R¹, R², and R³ in Formulas (I) is illustrated by vinyl, propenyl, butenyl, pentenyl, hexenyl, and octenyl. Alternatively, the alkenyl group comprises 2 to 8 carbon atoms. Alternatively, the alkenyl group is vinyl, allyl, or hexenyl.

The alkoxide group of R¹, R², and R³ in Formulas (I) has a general formula (II): R⁴O—. The R⁴ group of Formula (II) is an independently selected alkyl group having from 1 to 18 carbon atoms, or aryl group having from 6 to 12 carbon atoms. Alternatively, R⁴ is an alkyl group having from 1 to 6 carbon atoms (for instance, 1 to 4 carbon atoms), or aryl group having 6-8 carbon atoms. Alternatively, R⁴ is methyl, or ethyl, or phenyl.

The aryl group having 6 to 12 carbon atoms of R¹, R², and R³ in Formulas (I) is illustrated by phenyl, naphthyl, benzyl, tolyl, xylyl, methylphenyl, 2-phenylethyl, 2-phenyl-2-methylethyl, chlorophenyl, bromophenyl and fluorophenyl. Alternatively, the aryl group comprises 6 to 8 carbon atoms. Alternatively, the aryl group is phenyl. The epoxy group having 3-18 carbon atoms of R¹, R², and R³ in Formulas (I) may be glycidal ether groups, alkyl epoxy groups, or cycloaliphatic epoxy groups. The glycidyl ether group is illustrated by alkyl glycidyl ether groups such as 2-glycidoxyethyl, 3-glycidoxypropyl, 4-glycidoxybutyl, and 2-(3,4-epoxycyclohexyl)ethyl. Examples of the alkyl epoxy groups are 2,3-epoxypropyl, 3,4-epoxybutyl, and 4,5-epoxypentyl, and the cycloaliphatic epoxy group is illustrated by monovalent epoxycycloalkyl groups such as 3,4-epoxycyclohexylmethyl, 3,4-epoxycyclohexylethyl, 3,4-epoxycyclohexylpropyl, 3,4-epoxycyclohexylbutyl, and alkyl cyclohexene oxide groups. Alternatively, the epoxy group is 3-glycidoxypropyl.

The carbinol group having 1-18 carbon atoms of R¹, R², and R³ in Formulas (I) includes carbinol groups free of aryl groups having at least 3 carbon atoms and aryl-containing carbinol groups having at least 6 carbon atoms. Generally a “carbinol” group is any group containing at least one carbon-bonded hydroxyl (COH) group. Thus the carbinol group may contain more than one COH group such as for example

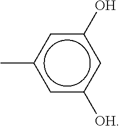

Carbinol groups free of aryl groups having at least 3 carbon atoms are illustrated by groups having the formula R⁷OH wherein R⁷ is a divalent hydrocarbon group having at least 3 carbon atoms or a divalent hydrocarbonoxy group having at least 3 carbon atoms. The group R⁷ may be an alkylene group illustrated by —(CH₂)ₛ— where s has a value of 3 to 10, a branched alkylene group having 3 to 12 carbon atoms, such as —CH₂CH(CH₃)—, —CH₂CH(CH₃)CH₂—, or —CH₂CH₂CH(CH₂CH₃)CH₂CH₂CH₂—, or —OCH(CH₃)(CH₂)ₜ— wherein t has a value of 1 to 10. The carbinol group free of aryl groups having at least 3 carbon atoms is also illustrated by groups having the formula R⁸(OH)CH₂OH where R⁸ is a group having the formula —CH₂CH₂(CH₂)ₜOCH₂CH— wherein t has a value of 1 to 10.

The aryl-containing carbinol groups having at least 6 carbon atoms are illustrated by groups having the formula R⁹OH wherein R⁹ is an arylene group selected from —(CH₂)ᵤC₆H₄—, —CH₂CH(CH₃)(CH₂)ᵤC₆H₄— wherein u has a value of 0 to 10, and —(CH₂)ₜC₆H₄(CH₂)_{u—} wherein u and t are as described above. Alternatively, the aryl-containing carbinol groups have from 6 to 14 carbon atoms, alternatively 6 to 10 carbon atoms.

The polyether group of R¹, R², and R³ in Formula (I) has the general formula: (III) —(R⁵O)_{q}R⁶, where q is a value from 1 to 30, each R⁵ is an independently selected divalent alkylene group having from 2 to 6 carbon atoms, and R⁶ is an independently selected hydrogen atom or monovalent alkyl group having from 1 to 6 carbon atoms.

Alternatively, each R¹, R², and R³ in Formula (I) is an independently selected hydrogen atom, or chlorine atom, or alkyl group having 1-6 carbon atoms, or alkenyl group having 2-6 carbon atoms, or aryl group having 6-8 carbons atoms, or alkoxide having 1-4 carbon atoms. Alternatively, each R¹, R², and R³ is hydrogen, chlorine, methyl, ethyl, vinyl, hexenyl, methoxide, ethoxide, or phenyl.

The SiH-containing composition may be a cyclic or linear compound containing from 1-10,000 (for instance, 1-1000, 1-200, or 1-100) of any combination of the following M, D, T, and Q building blocks. Examples of the SiH-containing materials described by Formula (I) that are useful in the methods of the invention include oligomeric and polymeric organosiloxanes, such as (i) cyclic compounds containing 3-25 D building blocks (for instance, 3-10 or 4-6 D building blocks); or (ii) linear compounds containing two M building block that act an end blocks, and 2-10,000 D building blocks (for instance, 2-1000, 2-200, 10-100, 50-80, 60-70, 2-20, or 5-10) between the end blocks.

Cyclic compounds falling within group (i) include those containing D building blocks where R¹ is hydrogen and R² is methyl; D building blocks where R¹ and R² are both methyl; and combinations thereof. Linear compounds falling within group (ii) include those containing M building blocks where R¹ is hydrogen, and R² and R³ are hydrogen; M building blocks where R¹, R², and R³ are methyl; D building blocks wherein R¹ is hydrogen and R² is methyl; D building blocks where R¹ and R² are both methyl; and combinations thereof. Various SiH-containing compounds would fall within these groups. For example, the following compounds, all of which are commercially available from Dow Corning, fall within these groups: (a) cyclic compounds containing 4-6 D building blocks, where R¹ and/or R² in each of the building blocks represents methyl and where, in at least one of the building blocks, R¹ or R² is hydrogen; (b) linear compounds containing two M building blocks where R¹ represent hydrogen or methyl, and R² and R³ represent methyl; (c) linear compounds containing two M building blocks as end blocks (for instance, M building blocks described above for group (b)), and 2-10 D building blocks between the end blocks, where, in at least one of the D building blocks, R¹ represents hydrogen and R² represents methyl, the remaining D building blocks having R¹ and R² both representing methyl; and (d) linear compounds containing two M building blocks as end blocks and 50-80 D building blocks where, in at least one of the D building blocks, R¹ represent hydrogen and R² represents methyl.

The SiH-containing composition may also be a silane having a general formula (IV): R¹⁰ᵣSiHₛY₄₋ᵣ₋ₛ, where Y is Cl or OR⁴; r is a value between 0 and 3; s is a value between 1 and 4; each R¹⁰ is an independently selected alkyl group having 1 to 18 carbon atoms or aryl group having from 6 to 12 carbon atoms; and R⁴ is an independently selected hydrogen atom or alkyl group having from 1 to 6 carbon atoms, aryl group having from 6 to 8 carbon atoms, or a polyether group having a general formula: (III) —(R⁵O)_{q}R⁶, where q is a value from 1 to 4, each R⁵ is an independently selected divalent alkylene group having from 2 to 6 carbon atoms, and R⁶ is an independently selected hydrogen atom or monovalent alkyl group having from 1 to 6 carbon atoms.

Examples of the SiH-containing materials described by Formula (IV) that are useful in the methods of this invention include PhMe₂SiH, Ph₂MeSiH, MeHSiCl₂, and MeHSi(OMe)₂. For PhMe₂SiH and Ph₂MeSiH, variables r+s=4, meaning that the Y group is not present.

Reacting the metal salt with the reducing material involves a chemical reaction well known by those of skill in the art. The reaction may take place at various temperatures and pressures. Reaction temperatures as low as −69° C. (the temperature of a dry ice bath) and as high as 140° C. (the boiling point of xylene) have been used. Higher temperatures could also be used, dependent upon the boiling point of the solvent being used. High temperatures, or even elevated temperatures, are not necessary, however. Indeed, the reduction reaction is able to take place at room temperature for many embodiments.

The reducing material is added to the metal salt either before or after the organopolysiloxane addition.

The organopolysiloxane composition may be defined as containing 1-10,000 building blocks which have an average formula (V): R¹¹_{d}R¹²ₑR¹³_{f}SiO_{(4-d-e-f)/2}, where d, e, and f are each an integer selected from 0, 1, 2, or 3, where d+e+f≦3, each R¹¹, R¹², and R¹³ is an independently selected hydrogen atom, or hydroxide group, or alkoxide group having a general formula (II): R⁴O—, where R⁴ is an alkyl group having 1-18 carbon atoms or an aryl group having from 6 to 12 carbon atoms, or alkyl group having 1 to 18 carbon atoms, or alkenyl group having 2-18 carbon atoms, or epoxy group having 3-18 carbon atoms, or carbinol group having 1-18 carbon atoms, or aryl group having from 6 to 12 carbon atoms, or amino group having 1-18 carbon atoms, or carboxylic acid group having 2-24 carbon atoms, or polyether group having a general formula: (III) —(R⁵O)_{q}R⁶, where q is a value from 1 to 30, each R⁵ is an independently selected divalent alkylene group having from 2 to 6 carbon atoms, and R⁶ is an independently selected hydrogen atom or monovalent alkyl group having from 1 to 6 carbon atoms.

Formula (V) may be represented by M, D, T, and Q building blocks as defined above, where the R¹, R², and R³ substituents are represented as groups R¹¹, R¹², and R¹³, respectfully. Thus, for the organopolysiloxane composition, the building blocks may be represented as:

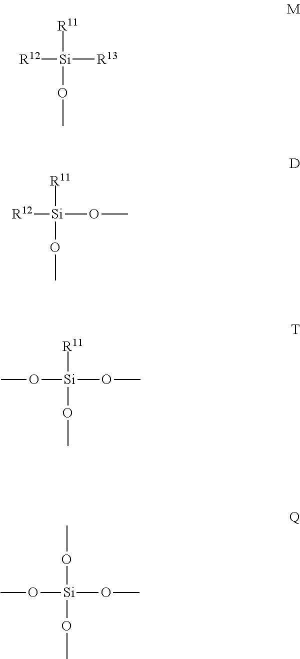

The number of building blocks (M, D, T, Q) in the organopolysiloxane compositions may range from 1 to 10,000, for instance from 4 to 1000.

The alkyl group having 1 to 18 carbon atoms of R¹¹, R¹², and R¹³ in Formula (V) is a monovalent alkyl group having from 1 to 18 carbon atoms. Alternatively, the alkyl group comprises 1 to 6 carbon atoms; alternatively, the alkyl group is methyl, ethyl, propyl, butyl, or hexyl.

The alkenyl group having 2-18 carbon atoms of R¹¹, R¹², and R¹³ in Formula (V) is illustrated by vinyl, propenyl, butenyl, pentenyl, hexenyl, and octenyl. Alternatively, the alkenyl group comprises 2 to 8 carbon atoms. Alternatively, the alkenyl group is vinyl, allyl, or hexenyl.

The alkoxide group of R¹¹, R¹², and R¹³ in Formula (V) has a general formula (II): R⁴O—. The R⁴ group of Formula (II) is an independently selected alkyl group having from 1 to 18 carbon atoms, or aryl group having from 6 to 12 carbon atoms. Alternatively, R⁴ is an alkyl group having from 1 to 6 carbon atoms (for instance, 1 to 4 carbon atoms), or aryl group having 6-8 carbon atoms. Alternatively, R⁶ is methyl, or ethyl, or phenyl.

The aryl group having 6 to 12 carbon atoms of R¹¹, R¹², and R¹³ in Formula (V) is illustrated by phenyl, naphthyl, benzyl, tolyl, xylyl, methylphenyl, 2-phenylethyl, 2-phenyl-2-methylethyl, chlorophenyl, bromophenyl and fluorophenyl. Alternatively, the aryl group comprises 6 to 8 carbon atoms. Alternatively, the aryl group is phenyl.

The epoxy group having 3-18 carbon atoms of R¹¹, R¹², and R¹³ in Formula (V) may be glycidal ether groups, alkyl epoxy groups, or cycloaliphatic epoxy groups. The glycidyl ether group is illustrated by alkyl glycidyl ether groups such as 2-glycidoxyethyl, 3-glycidoxypropyl, 4-glycidoxybutyl, and 2-(3,4-epoxycyclohexyl)ethyl. Examples of the alkyl epoxy groups are 2,3-epoxypropyl, 3,4-epoxybutyl, and 4,5-epoxypentyl, and the cycloaliphatic epoxy group is illustrated by monovalent epoxycycloalkyl groups such as 3,4-epoxycyclohexylmethyl, 3,4-epoxycyclohexylethyl, 3,4-epoxycyclohexylpropyl, 3,4-epoxycyclohexylbutyl, and alkyl cyclohexene oxide groups. Alternatively, the epoxy group is 3-glycidoxypropyl.

The carbinol group having 1-18 carbon atoms of R¹¹, R¹², and R¹³ in Formula (IV) includes carbinol groups free of aryl groups having at least 3 carbon atoms and aryl-containing carbinol groups having at least 6 carbon atoms. Generally a “carbinol” group is any group containing at least one carbon-bonded hydroxyl (COH) group. Thus the carbinol group may contain more than one COH group such as for example

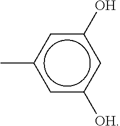

Carbinol groups free of aryl groups having at least 3 carbon atoms are illustrated by groups having the formula R⁷OH wherein R⁷ is a divalent hydrocarbon group having at least 3 carbon atoms or a divalent hydrocarbonoxy group having at least 3 carbon atoms. The group R⁷ may be an alkylene group illustrated by —(CH₂)ₛ— where s has a value of 3 to 10, a branched alkylene group having 3 to 12 carbon atoms, such as —CH₂CH(CH₃)—, —CH₂CH(CH₃)CH₂—, or —CH₂CH₂CH(CH₂CH₃)CH₂CH₂CH₂—, or —OCH(CH₃)(CH₂)ₜ— wherein t has a value of 1 to 10. The carbinol group free of aryl groups having at least 3 carbon atoms is also illustrated by groups having the formula R⁸(OH)CH₂OH where R⁸ is a group having the formula —CH₂CH₂(CH₂)ₜOCH₂CH— wherein t has a value of 1 to 10.

The aryl-containing carbinol groups having at least 6 carbon atoms are illustrated by groups having the formula R⁹OH wherein R⁹ is an arylene group selected from —(CH₂)ᵤC₆H₄—, —CH₂CH(CH₃)(CH₂)ᵤC₆H₄— wherein u has a value of 0 to 10, and —(CH₂)ₜC₆H₄(CH₂)_{n—} wherein u and t are as described above. Alternatively, the aryl-containing carbinol groups have from 6 to 14 carbon atoms, alternatively 6 to 10 carbon atoms.

The polyether group of R¹¹, R¹², and R¹³ in Formula (V) has the general formula: (III) —(R⁵O)_{q}R⁶, where q is a value from 1 to 30, each R⁵ is an independently selected divalent alkylene group having from 2 to 6 carbon atoms, and R⁶ is an independently selected hydrogen atom or monovalent alkyl group having from 1 to 6 carbon atoms.

The amino group of R¹¹, R¹², and R¹³ in Formula (V) typically has the formula —R⁹NHR¹⁰ or —R⁹NHR⁹NHR¹⁰ wherein each R⁹ is independently a divalent hydrocarbon radical having at least 2 carbon atoms and R¹⁰ is hydrogen or an alkyl group having from 1 to 18 carbon atoms. Examples of the R⁹ group include an alkylene radical having from 2 to 20 carbon atoms and are illustrated by —CH₂CH₂—, —CH₂CH₂CH₂—, —CH₂CHCH₃—, —CH₂CH₂CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. Alternatively, the alkyl group of R¹⁰ is methyl, ethyl, propyl, butyl, hexyl, octyl, decyl, dodecyl, hexadecyl, or octadecyl. Alternatively, when R¹⁰ is an alkyl group, it is methyl.

Typical aminofunctional hydrocarbon groups are —CH₂CH₂NH₂, —CH₂CH₂CH₂NH₂, —CH₂CHCH₃NH, —CH₂CH₂CH₂CH₂NH₂, —CH₂CH₂CH₂CH₂CH₂NH₂, —CH₂CH₂CH₂CH₂CH₂CH₂NH₂, —CH₂CH₂NHCH₃, —CH₂CH₂CH₂NHCH₃, —CH₂(CH₃)CHCH₂NHCH₃, —CH₂CH₂CH₂CH₂NHCH₃, —CH₂CH₂NHCH₂CH₂NH₂, —CH₂CH₂CH₂NHCH₂CH₂CH₂NH₂, —CH₂CH₂CH₂CH₂NHCH₂CH₂CH₂CH₂NH₂, —CH₂CH₂NHCH₂CH₂NHCH₃, —CH₂CH₂CH₂NHCH₂CH₂CH₂NHCH₃, —CH₂CH₂CH₂CH₂NHCH₂CH₂CH₂CH₂NHCH₃, and —CH₂CH₂NHCH₂CH₂NHCH₂CH₂CH₂CH₃.

The carboxylic acid group of R¹¹, R¹², R¹³ in Formula (V) typically has the formula —R¹⁴COOH, where R¹⁴ is a divalent hydrocarbon radical having at least 1 carbon atom. Examples of the R¹⁴ group include an alkylene radical having from 1 to 20 carbon atoms and are illustrated by —CH₂—, —CH₂CH₂—, —CH₂CH₂CH₂—, —CH₂CHCH₃—, —CH₂CH₂CH₂CH₂—, —CH₂CH(CH₃)CH₂—, —CH₂CH₂CH₂CH₂CH₂—, —CH₂CH₂CH₂CH₂CH₂CH₂—, —CH₂CH₂CH(CH₂CH₃)CH₂CH₂CH₂—, —CH₂CH₂CH₂CH₂CH₂CH₂CH₂CH₂—, and —CH₂CH₂CH₂CH₂CH₂CH₂CH₂CH₂CH₂CH₂—. Alternatively, each R¹¹, R¹², and R¹³ in Formula (V) is an independently selected hydrogen atom, or alkyl group having 1-6 carbon atoms, or alkenyl group having 2-6 carbon atoms, or aryl group having 6-8 carbons atoms, or alkoxide having 1-4 carbon atoms. Alternatively, each R¹, R², and R³ is an independently selected hydrogen, methyl, ethyl, vinyl, hexenyl, methoxide, ethoxide, or phenyl.

Examples of the organosiloxanes described by Formula (V) that are useful in the methods of the invention include oligomeric and polymeric organosiloxanes, such as polydimethylsiloxane, vinyl-functional polydimethylsiloxane, amine-functional polydimethylsiloxane, epoxy-functional polydimethylsiloxane, carbinol-functional polydimethylsiloxane, polyether-functional polydimethylsiloxane, carboxylic acid functional polydimethylsiloxane, polymethylmethoxysiloxane, polysilsesquioxane, MQ resin, and combinations thereof.

Particular examples of organopolysiloxane compositions include polydialkylsiloxane, hexenyldimethylsiloxy-terminated polydimethylsiloxane-polymethylhexenylsiloxane copolymers, hexenyldimethylsiloxy-terminated polydimethylsiloxane polymers, vinyldimethylsiloxy-terminated polydimethylsiloxane polymers, vinyl or hexenyldimethylsiloxy-terminated poly(dimethylsiloxane-silicate) copolymers, mixed trimethylsiloxy-vinyldimethylsiloxy terminated poly(dimethylsiloxane-vinylmethylsiloxane-silicate) copolymers, vinyl or hexenyldimethylsiloxy terminated poly(dimethylsiloxane-hydrocarbyl) copolymers, derivatives thereof, and combinations thereof. Oganopolysiloxane copolymers include block copolymer and random copolymers. For example, PEO-b-PDMS ABn block copolymer represents a type of organopolyxiloxane block copolymer utilizing polyethylene oxide. Other suitable organopolysiloxane compositions (also referred to as organosiloxane polymers) are disclosed in U.S. Pat. No. 7,687,591, herein incorporated by reference in its entirety. For instance, the organopolysiloxane composition may be polydimethylsiloxane, polymethylphenylsiloxane, polydiphenylsiloxane, phenylsilsesquioxane, methylsilsesquioxane, SiO4/2, or copolymers thereof.

Functional groups may be present at any point in the organopolysiloxane composition, for example, in the middle of the polymer or as a reactive endgroup(s). Typical functional groups, such as diorgano-, —OH, -vinyl, -hexenyl, -epoxy, and -amine may be used in the organopolysiloxane compositions contemplated herein. End groups such as Me₃, Ph₂Me, Me₂Ph may or may not be present in the organopolysiloxane composition.

The organopolysiloxane composition can also be random or block copolymers of the organopolysiloxane with organic polymers. Examples include, but not limited to, polyether-polydimethylsilxoane copolymers and hexadiene-polydimethylsiloxane copolymers.

Although not necessary, stabilizers may be added to assist in dispersing the metal in the silicone composition or otherwise making the composition more stable. While the stability of the metal nanoparticle dispersion is desirable, stability is dependent on various other aspects besides the stabilizer, such as the particle size, the metal concentration, the molecular weight of the silicone materials, and the functionality of the silicone materials. Adjusting or accounting for these other aspects allows one skilled in the art to obtain good dispersion and stability without necessarily having to use a stabilizer.

Removing the solvent can take place through procedures well known in the art. For instance, the solvent may be removed at ambient or reduced pressure at ambient or elevated temperature. Advantageously, solvent removal takes place after the nanoparticles are formed, but before the composition is formulated into a curable composition. While a solvent may be used to facilitate salt dispersion, after the solvent has been removed, the nanoparticles are considered to be in a solvent-free form. This feature distinguishes this invention over many other processes known in the art, where solvent removal, by nature of the compounds used and the methods used to prepare the compositions, is difficult to impossible.

The average particle size of the nanoparticles in the nanoparticle-containing silicone composition can be varied from about 1 to about 100 nm depending on the desired product. Alternatively, the average particle size ranges from about 2 to about 30 nm, alternatively from about 5 to about 25 nm.

The metal concentration in the nanoparticle-containing silicone composition ranges from about 1 ppm to about 100,000 ppm. Alternatively, the metal concentration in the silicone dispersion ranges from about 50 ppm to about 50,000 ppm, about 100 ppm to about 30,000 ppm, about 500 ppm to about 20,000 ppm. The metal concentration may also be stated in weight percent. When stated in weight percent, the resulting product typically contains about 0.0001% to about 10% metal, for example, about 0.005% to about 5% metal, about 0.01 to about 3% metal, about 0.05% to about 2% metal.

Once the nanoparticle-containing silicone composition has been prepared, it can be used as an additive to any composition, curable or not. Advantageously, curing does not have to take place in situ through a polymerization agent that is being used as the reducing material or otherwise present in the composition. This accords the end user greater flexibility in formulating the final composition and in deciding how and when to cure the composition. If the nanoparticle-containing silicone composition contains functional groups (such as vinyl, SiH, epoxy, alkoxy, etc.), adding curing agents to the nanoparticle-embedded silicone composition produces a curable metal nanoparticle-containing silicone composition, which can then be cured to produce a cured metal nanoparticle-containing silicone composition. If the nanoparticle-containing silicone composition does not contain functional groups, then the composition can be formulated into other curable silicone compositions so that the entire composition can be cured. Either way, the nanoparticle-containing silicone composition may be used as an additive to a silicon composition and then cured.

The composition can be cured through a variety of polymerization reactions including condensation reactions, addition reactions, and free-radical polymerization. Alternatively, the compositions may be cured through a peroxide cure, a radiation cure, or other curing techniques known to those of skill in the art.

Curing agents and other materials known to those of skill in the art may be used to make a curable composition. Typical materials include polymers (including silicon-based polymers, such as the organopolysiloxane compositions described above), catalysts, crosslinkers, inhibitors, solvents, and combinations thereof. Even though the solvent has been removed in an earlier step, solvent can be added later in the curing step if a solvent-borne system is desired.

Catalysts suitable for use in the curing include Ti, Sn, Pt, and other condensation cure, addition cure, and radical cure catalysts, as known to those in the art.

Inhibitors include any material that is known to be, or can be, used to inhibit the catalytic activity of the catalysts, known to those in the art.

The cured metal nanoparticle-containing silicone compositions can be used in a variety of different silicon compositions, including silicon articles, such as elastomers, coatings, adhesives, medical tubing, catheters, and medical parts. Various articles and profiles that may be produced from the polymerized or cured composition are disclosed in U.S. Pat. No. 6,914,091, herein incorporated by reference in its entirety.

### EXAMPLES

Example 1: 1.60 g silver neodecanoate was dissolved in 26 g chloroform. 30.5 g of a vinyl end-functional polydimethylsiloxane polymer (an organopolysiloxane commercially available from Dow Corning) was added and the mixture was stirred 30 minutes. 0.40 g of a methyl-hydrogen functional siloxane (a SiH-containing composition commercially available from Dow Corning) was added. Stirring was continued for 30 minutes. A dark brown solution formed. Solvent was removed under vacuum. The resulting product contained 1.8% Ag nanoparticles.

Example 2: 3.92 g silver neodecanoate was dissolved in 10 g methylene dichloride. 7.4 g divinyltetramethyldisiloxane (an organopolysiloxane commercially available from Dow Corning) was added. The methylene dichloride was removed under vacuum. 1.60 g a methyl-hydrogen functional cyclo-siloxane (a SiH-containing composition commercially available from Dow Corning) was added and the mixture was stirred for 30 minutes at room temperature (RT). A dark brown solution formed. 48.7 g vinyl end-functional polydimethylsiloxane polymer (an organopolysiloxane commercially available from Dow Corning) and 81.2 g a vinyl end-functional polydimethylsiloxane polymer (an organopolysiloxane commercially available from Dow Corning) was added. The solvent was removed under vacuum. The resulting product contained 1.0% Ag nanoparticles.

Example 3: 2.82 g silver neodecanoate was dissolved in 115 g methylene dichloride. 1.15 g a methyl-hydrogen functional cyclo-siloxane (a SiH-containing composition commercially available from Dow Corning) was added and the mixture was stirred at RT for 30 minutes. A dark brown solution formed. 172 g a vinyl end-functional polydimethylsiloxane polymer (an organopolysiloxane commercially available from Dow Corning) was added. The solvent was removed under vacuum. The resulting product contained 0.58% Ag nanoparticles.

Example 4: 3.0 g silver neodecanoate was dissolved in 120 g methylene dichloride. 1.23 g a methyl-hydrogen functional cyclo-siloxane (a SiH-containing composition commercially available from Dow Corning) was added and stirred at RT for 30 minutes. A dark brown solution formed. 179.2 g a vinyl end-functional polydimethylsiloxane polymer (an organopolysiloxane commercially available from Dow Corning) was added to the mixture. The solvent was removed under vacuum. The resulting product contained 0.60% Ag nanoparticles.

Example 5: Example 4 was repeated except that toluene was used as the solvent (which was removed after the production under vacuum). The resulting product contained 0.60% Ag nanoparticles.

Example 6: Example 4 was repeated except that THF was used as the solvent (which was removed after the production under vacuum). The resulting product contained 0.60% Ag nanoparticles.

Example 7: Example 4 was repeated, except that heptanes were used as the solvent and a methyl-hydrogen-co-dimethyl siloxane (a SiH-containing composition commercially available from Dow Corning) was used as the reducing agent. The solvent was removed after the production using a vacuum. The resulting product contained 0.60% Ag nanoparticles.

Example 8: Example 4 was repeated, except that PhMe₂SiH was used as the reducing agent. The resulting product contained 0.60% Ag nanoparticles.

Example 9: Example 4 was repeated, except that Ph₂MeSiH was used as the reducing agent. The resulting product contained 0.59% Ag nanoparticles.

Example 10 (comparative): Example 4 was repeated, except that vegetable oil was used as the solvent. Vegetable was not compatible with the silicone fluid, making it difficult to remove under vacuum due to its high boiling point.

Example 11: Example 4 was repeated, except that silver 2-ethylhexanoate was used as the metal salt. (Silver 2-ethylhexanoate was prepared by mixing equal moles of silver nitrate and sodium 2-ethylhexanoate using a water-ethanol mixture as the solvent. White solid was collected by filtering, washing, and drying processes.) The resulting product contained 0.60% Ag nanoparticles.

Example 12: Example 4 was repeated, except that a PEO-grafted PDMS (containing 5% PEO; commercially available from Dow Corning) was used as the organopolysiloxane composition. The resulting product contained 0.60% Ag nanoparticles.

Example 13: Example 12 was repeated, except that a PEO-b-PDMS ABn block copolymer (containing 23% PEO; commercially available from Dow Corning) was used as the organopolysiloxane composition. The resulting product contained 1.15% Ag nanoparticles.

Example 14: Example 5 was repeated, except that the reaction took place under dry ice bath (−69° C.). The reaction proceeded very slowly. The solution changed to dark brown after 24 hours. The resulting product contained 0.60% Ag nanoparticles after solvent removal.

Example 15: Example 5 was repeated, except that the reaction took place under reflux temperature (110° C.). The solution changed to dark brown immediately after adding the reducing agent. The resulting product contained 0.60% Ag nanoparticles after solvent removal.

Example 16: A 3.26 g sample from example 3 was mixed with an additional 5.0 g a vinyl end-functional polydimethylsiloxane polymer (an organopolysiloxane commercially available from Dow Corning), 11.0 g a vinyl end-functional polydimethylsiloxane polymer (an organopolysiloxane commercially available from Dow Corning), 0.30 g a methyl-hydrogen-co-dimethyl siloxane (a SiH-containing composition that can also act as a crosslinker; commercially available from Dow Corning), and 0.26 g of a Pt catalyst complex (commercially available from Dow Corning) and degassed at RT. The composition was then cured at 130° C. for 5 minutes.

Example 17: A 2.0 g sample from example 4 was mixed with 4.9 g a vinyl end-functional polydimethylsiloxane polymer (an organopolysiloxane commercially available from Dow Corning), 4.9 g a vinyl end-functional polydimethylsiloxane polymer (an organopolysiloxane commercially available from Dow Corning), 0.18 g a methyl-hydrogen-co-dimethyl siloxane (a SiH-containing composition that can also act as a crosslinker; commercially available from Dow Corning), and 0.16 g of a Pt catalyst complex (commercially available from Dow Corning) and degassed at RT. The composition was cured at 130° C. for 5 minutes.

Example 18: 20 mg AuCl₃ were dissolved in 20 g THF and 12.9 g a vinyl end-functional polydimethylsiloxane polymer (an organopolysiloxane commercially available from Dow Corning). 21 mg a methyl-hydrogen functional cyclo-siloxane (a SiH-containing composition commercially available from Dow Corning) was added to the mixture under stirring. The solution changed to a purple color. The solvent was removed after 30 minutes. The resulting product contained 0.1% Au nanoparticles.

Each reference disclosed herein is incorporated by reference herein in its entirety.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

1. A method of preparing a solvent-free, uncured metal nanoparticle-containing silicone composition, comprising:
a. reacting a soluble metal salt dissolved in an organic solvent with a reducing material to form a mixture;
b. adding an organopolysiloxane composition to the mixture; and
c. removing the organic solvent to form a solvent-free, uncured metal nanoparticle-containing silicone composition.

2. (canceled)

3. The method of claim 1, wherein the metal of the soluble metal salt is selected silver, gold, copper, platinum, palladium, ruthenium, and rhodium.

4-6. (canceled)

7. The method of claim 1, wherein the organic solvent is a polar or a non-polar solvent selected from tetrahydrofuran, chloroform, methylene chloride, toluene, xylene, heptanes, ethanol, butanol, and mixtures thereof.

8. The method of claim 1, wherein the reducing material is a SiH-containing composition or a compound containing one or more aldehyde groups.

9. (canceled)

10. The method of claim 1, wherein the reducing material is a SiH-containing composition, the SiH-containing composition comprises 1 to 10,000 building blocks of the formula (I): R¹ₐR²_{b}R³_{c}SiO_{(4-a-b-c)/2}, wherein:
each of a, b, and c is independently an integer selected from 0, 1, 2, or 3, where a+b+c≦3,
each R¹, R², and R³ is independently a hydrogen atom, chlorine atom, hydroxide group, alkoxide group, alkyl group having 1 to 18 carbon atoms, alkenyl group having 2-18 carbon atoms, epoxy group having 3-18 carbon atoms, carbinol group having 1-18 carbon atoms, aryl group having from 6 to 12 carbon atoms, or a polyether group; wherein the alkoxide group has the formula (II): R⁴O— and 1-18 carbon atoms, where R⁴ is an alkyl group having from 1 to 18 carbon atoms or an aryl group having from 6 to 12 carbon atoms, and wherein the polyether has the formula: (III) —(R⁵O)_{q}R⁶, where q is a value from 1 to 30, each R⁵ is independently a divalent alkylene group having from 2 to 6 carbon atoms, and R⁶ is a hydrogen atom or monovalent alkyl group having from 1 to 6 carbon atoms;
with the proviso that, for at least one building block, R¹, R², or R³ is hydrogen.

11. The method of claim 1, wherein the reducing material is a SiH-containing composition, the SiH-containing composition is a compound containing from 1-1000 of any combination of the following M, D, T, and Q building blocks: 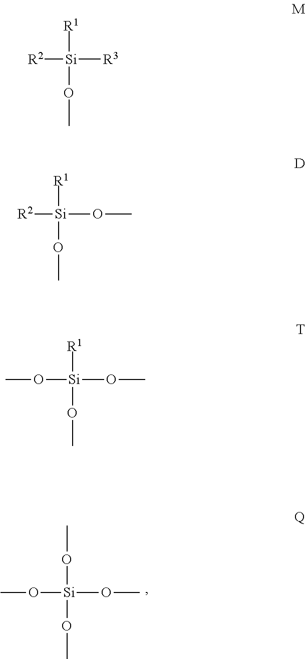
wherein R¹, R², and R³ each independently are selected from hydrogen, an alkyl group having from 1 to 6 carbon atoms, an alkenyl group having from 2 to 8 carbon atoms, an aryl group having from 6 to 12 carbons atoms, and (R⁵O)_{q}R⁶, where q is a value from 1 to 30, each R⁵ is an independently selected divalent alkylene group having from 2 to 6 carbon atoms, R⁶ is an hydrogen atom or monovalent alkyl group having from 1 to 6 carbon atoms; and
wherein each open bond off the oxygen atoms (—O——) indicates either a position where that building block may be bonded to another building block or is represented as —OR′ where R′ is hydrogen, a C₁-C₁₈ alkyl, or a C₆-C₁₂ aryl;
provided that building block M, D, or T is present at least once and, in at least one building block, R¹, R², or R³ is hydrogen.

12. The method of claim 1, wherein the reducing material is a SiH-containing composition, the SiH-containing composition is (i) a cyclic compound containing 4-6 D building blocks, where R¹ and/or R² in each of the building blocks represents methyl and where, in at least one of the building blocks, R¹ or R² is hydrogen; (ii) a linear compound containing two M building blocks where R¹ represent hydrogen or methyl, and R² and R³ represent methyl; (iii) a linear compound containing two M building blocks as end blocks and 2-10 D building blocks between the end blocks, where, in at least one of the D building blocks, R¹ represents hydrogen and R² represents methyl; or (iv) a linear compound containing two M building blocks as end blocks and 50-80 D building blocks where, in at least one of the D building blocks, R¹ represent hydrogen and R² represents methyl.

13. The method of claim 1, wherein the reducing material is a SiH-containing composition, the SiH-containing composition is a compound of the formula:
R⁷ᵣSiHₛY₄₋ᵣ₋ₛ, where Y is Cl or OR⁶; r ranges from 0 and 3; s ranges from 1 and 4; each R⁷ is independently an alkyl group having from 1 to 6 carbon atoms, alkenyl group having 2-18 carbon atoms, or an aryl group having from 6 to 12 carbons atoms; and R⁶ is independently hydrogen, an alkyl group having from 1 to 6 carbon atoms, an aryl group having from 6 to 8 carbon atoms, or a polyether group having a general formula (III) —(R⁵O)_{q}R⁶, where q is a value from 1 to 4, each R⁵ is independently a divalent alkylene group having from 2 to 6 carbon atoms, and R⁶ is hydrogen or a monovalent alkyl group having from 1 to 6 carbon atoms.

14. (canceled)

15. The method of claim 1, wherein the organopolysiloxane composition comprises 1 to 10,000 building blocks of the formula (I): R¹¹ₐR¹²_{b}R¹³_{c}SiO_{(4-d-e-f)/2}, wherein:
each of d, e, and f is independently an integer selected from 0, 1, 2, or 3, where d+e+f≦3, and
each R¹¹, R¹², and R¹³ is independently a hydrogen atom, chlorine atom, hydroxide group, alkoxide group, alkyl group having 1 to 18 carbon atoms, alkenyl group having 2-18 carbon atoms, epoxy group having 3-18 carbon atoms, carbinol group having 1-18 carbon atoms, aryl group having from 6 to 12 carbon atoms, or a polyether group; wherein the alkoxide group has the formula (II): R⁴O— and 1-18 carbon atoms, where R⁴ is an alkyl group having from 1 to 18 carbon atoms or an aryl group having from 6 to 12 carbon atoms, and wherein the polyether has the formula: (III) —(R⁵O)_{q}R⁶, where q is a value from 1 to 30, each R⁵ is independently a divalent alkylene group having from 2 to 6 carbon atoms, and R⁶ is a hydrogen atom or monovalent alkyl group having from 1 to 6 carbon atoms, or
4-1000 of any combination of the following M, D, T, and Q building blocks: 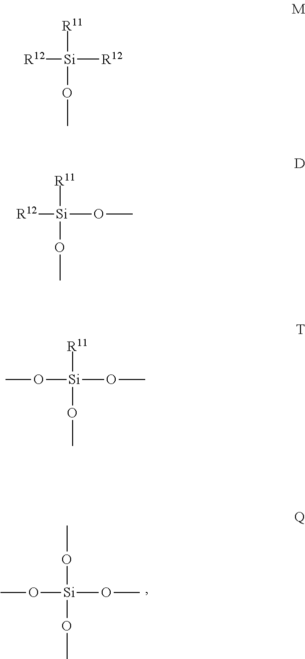
wherein R¹¹, R¹², and R¹³ each independently are selected from hydrogen, an alkyl group having from 1 to 6 carbon atoms, an alkenyl group having from 2 to 8 carbon atoms, an aryl group having from 6 to 12 carbons atoms, and (R⁵O)_{q}R⁶, where q is a value from 1 to 30, each R⁵ is an independently selected divalent alkylene group having from 2 to 6 carbon atoms, R⁶ is an hydrogen atom or monovalent alkyl group having from 1 to 6 carbon atoms; and
wherein each open bond off the oxygen atoms (—O——) indicates either a position where that building block may be bonded to another building block or is represented as —OR′ where R′ is hydrogen, a C₁-C₁₈ alkyl, or a C₆-C₁₂ aryl.

16. (canceled)

17. The method of claim 1, wherein the organopolysiloxane composition is selected from polydialkylsiloxane, hexenyldimethylsiloxy-terminated polydimethylsiloxane-polymethylhexenylsiloxane copolymers, hexenyldimethylsiloxy-terminated polydimethylsiloxane polymers, vinyldimethylsiloxy-terminated polydimethylsiloxane polymers, vinyl or hexenyldimethylsiloxy-terminated poly(dimethylsiloxane-silicate) copolymers, mixed trimethylsiloxy-vinyldimethylsiloxy terminated poly(dimethylsiloxane-vinylmethylsiloxane-silicate) copolymers, vinyl or hexenyldimethylsiloxy terminated poly(dimethylsiloxane-hydrocarbyl) copolymers, derivatives thereof, and combinations thereof.

18. (canceled)

19. The method of claim 1, wherein the nanoparticles in the nanoparticle-containing silicone composition have an average particle size of about 1 to about 100 nm.

20-22. (canceled)

23. The method of claim 1, further comprising the steps of adding other ingredients to the nanoparticle-containing silicone composition to make a curable silver nanoparticle-containing silicone composition and then curing the curable silver nanoparticle-containing silicone composition.

24. (canceled)

25. An article comprising a cured silver nanoparticle-containing silicon composition prepared from the method of claim 12.

26. (canceled)

27. A method of preparing a solvent-free, uncured metal nanoparticle-containing silicone composition, comprising:
a. adding a soluble metal salt dissolved in an organic solvent to an organopolysiloxane composition to form a mixture;
b. adding a reducing material to the mixture; and
c. removing the organic solvent
to form a solvent-free, uncured metal nanoparticle-containing silicone composition.

28. The method of claim 27, wherein the metal of the soluble metal salt is selected from silver, gold, copper, platinum, palladium, ruthenium, and rhodium.

29. The method of claim 27, wherein the organic solvent is a polar or a non-polar solvent selected from tetrahydrofuran, chloroform, methylene chloride, toluene, xylene, heptanes, ethanol, butanol, and mixtures thereof.

30. The method of claim 27, wherein the reducing material is a SiH-containing composition or a compound containing one or more aldehyde groups.

31. The method of claim 27, wherein the organopolysiloxane composition comprises 1 to 10,000 building blocks of the formula (I): R¹¹ₐR¹²_{b}R¹³_{c}SiO_{(4-d-e-f)/2}, wherein
each of d, e, and f is independently an integer selected from 0, 1, 2, or 3, where d+e+f≦3, and
each R¹¹, R¹², and R¹³ is independently a hydrogen atom, chlorine atom, hydroxide group, alkoxide group, alkyl group having 1 to 18 carbon atoms, alkenyl group having 2-18 carbon atoms, epoxy group having 3-18 carbon atoms, carbinol group having 1-18 carbon atoms, aryl group having from 6 to 12 carbon atoms, or a polyether group; wherein the alkoxide group has the formula (II): R⁴O— and 1-18 carbon atoms, where R⁴ is an alkyl group having from 1 to 18 carbon atoms or an aryl group having from 6 to 12 carbon atoms, and wherein the polyether has the formula: (III) —(R⁵O)_{q}R⁶, where q is a value from 1 to 30, each R⁵ is independently a divalent alkylene group having from 2 to 6 carbon atoms, and R⁶ is a hydrogen atom or monovalent alkyl group having from 1 to 6 carbon atoms, or
4-1000 of any combination of the following M, D, T, and Q building blocks: 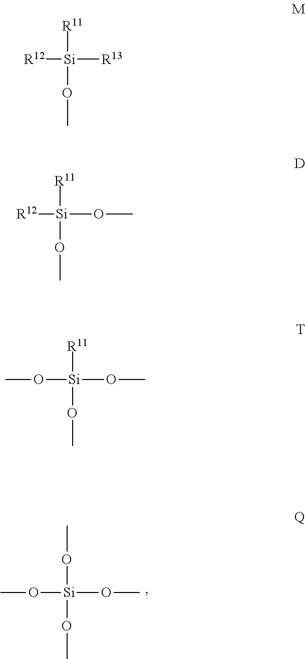
wherein R¹¹, R¹², and R¹³ each independently are selected from hydrogen, an alkyl group having from 1 to 6 carbon atoms, an alkenyl group having from 2 to 8 carbon atoms, an aryl group having from 6 to 12 carbons atoms, and (R⁵O)_{q}R⁶, where q is a value from 1 to 30, each R⁵ is an independently selected divalent alkylene group having from 2 to 6 carbon atoms, R⁶ is an hydrogen atom or monovalent alkyl group having from 1 to 6 carbon atoms; and
wherein each open bond off the oxygen atoms (—O——) indicates either a position where that building block may be bonded to another building block or is represented as —OR′ where R′ is hydrogen, a C₁-C₁₈ alkyl, or a C₆-C₁₂ aryl.

32. The method of claim 27, wherein the organopolysiloxane composition is selected from polydialkylsiloxane, hexenyldimethylsiloxy-terminated polydimethylsiloxane-polymethylhexenylsiloxane copolymers, hexenyldimethylsiloxy-terminated polydimethylsiloxane polymers, vinyldimethylsiloxy-terminated polydimethylsiloxane polymers, vinyl or hexenyldimethylsiloxy-terminated poly(dimethylsiloxane-silicate) copolymers, mixed trimethylsiloxy-vinyldimethylsiloxy terminated poly(dimethylsiloxane-vinylmethylsiloxane-silicate) copolymers, vinyl or hexenyldimethylsiloxy terminated poly(dimethylsiloxane-hydrocarbyl) copolymers, derivatives thereof, and combinations thereof.

33. The method of claim 27, wherein the nanoparticles in the nanoparticle-containing silicone composition have an average particle size of about 1 to about 100 nm.
